(19) United States
(12) Patent Application Publication
(10) Pub. No.: US 2008/0305758 A1
(43) Pub. Date: Dec. 11, 2008

(54) WIRELESS COMPUTER MOUSE RECEIVER

(76) Inventor: Thomas W. Hatch, Bonita Springs, FL (US)

Correspondence Address: EDWARD M. LIVINGSTON, PA, 963 TRAIL TERRACE DRIVE, NAPLES, FL, 34103, US

(21) Appl. No.: 11/758,211

(22) Filed: Jun. 5, 2007

(51) Int. Cl. H04B 7/00

(52) U.S. Cl. 455/269

(57) ABSTRACT

A wireless computer mouse receiver (1) having an exterior body (2) of sufficient predetermined vertical height to improve line-of-sight reception from a wireless mouse (5). Preferably the exterior body (2) would replicate the original World Trade Center prior to the terrorist attacks on Sep. 11, 2001 with a north tower (14) and a south tower (15). The wireless computer mouse receiver (1) is used in conjunction with a wireless mouse (5) capable of transmitting at least one signal (10), which may be radio frequency, laser or other types of signals (10). A means for receiving the signal (8) from the wireless mouse (5) is located on the wireless computer mouse receiver (1).

### BACKGROUND OF THE INVENTION

This invention relates to wireless computer mouse receivers, more particularly, a wireless computer mouse receiver having a predetermined height to permit better reception between a wireless mouse and the wireless mouse receiver.

Peripheral devices for computers, such as a mouse and printer, have become a staple in many homes and businesses using computers. The peripheral devices are commonly plugged into a port located on a rear side of a central processing unit (if a personal computer is used) or directly into the computer itself (if a laptop computer is used) via a cable that is either permanently or removably attached to the peripheral device. The cable has a predetermined length that usually provides enough distance for a user to comfortably use the peripheral device in relation to the computer. Over time, however, technology has advanced such that wireless peripherals have become increasingly popular among consumers.

Rather than having the peripheral devices physically attached to the computer, wireless peripherals permit a user to use the peripheral device without having to physically plug the peripheral device into the computer. The wireless peripheral device acts as a transmitter to transmit a signal to relay data, such as movement or clicks as in the case of a wireless mouse, to a receiver that is physically connected to the computer. In this manner, users are not limited by the length of a cable in order to use the peripheral device. In addition, users also prefer to use wireless peripherals over traditional cable peripherals so as to not have unattractive cables in his/her view or encumbering his/her workspace.

Although the benefits of using wireless peripheral devices are many, there is one major flaw: the peripheral device must always be in a line of sight with the receiver in order to properly function as the signal strength of the receiver is of a minimal amount. Although this requirement is obvious and seems simple to comply with, when a person is using a wireless peripheral, especially a wireless mouse, a direct line of sight between the wireless peripheral and receiver is not always available due to the receiver being substantially flat, low-lying and located in an inconvenient place. In addition, if a person is working at a limited workspace, oftentimes papers get in the way of the line of sight, thereby preventing the wireless mouse from transmitting data to the receiver.

Thus, a need exists for a wireless computer mouse receiver having a predetermined height to permit better reception between a wireless mouse and the wireless computer mouse receiver.

The relevant prior art includes the following references:

| Patent No. | | |
|---|---|---|
| (U.S. unless stated otherwise) | Inventor | Issue/Publication Date |
| D532,776 | Griffin | Nov. 28, 2006 |
| Des. 357,019 | Rasansky et al. | Apr. 04, 1995 |
| D496,048 | Chen | Sep. 14, 2004 |
| 5,945,981 | Paull et al. | Aug. 31, 1999 |
| 6,801,967 | Nakamura et al. | Oct. 05, 2004 |
| 6,970,955 | Chen | Nov. 29, 2005 |
| 6,255,800 | Bork | Jul. 03, 2001 |
| D515,579 | Chang | Feb. 21, 2006 |

### SUMMARY OF THE INVENTION

The primary object of the present invention is to provide a wireless computer mouse receiver having a predetermined height to permit better reception between a wireless mouse and the wireless computer mouse receiver.

A further object of the present invention is to provide a wireless computer mouse receiver that is attractive.

An even further object of the present invention is to provide a wireless computer mouse receiver having a strong signal strength.

Another object of the present invention is to provide a wireless computer mouse receiver having an antenna.

The present invention fulfills the above and other objects by providing a wireless computer mouse receiver having a predetermined vertical height for improved reception of transmission from a computer mouse. The wireless computer mouse receiver of the present invention preferably has an exterior body having a north tower and a south tower to replicate the original World Trade Center prior to the terrorist attacks on Sep. 11, 2001 and is used in conjunction with a wireless mouse capable of transmitting at least one signal, which may be radio frequency, laser or other types of signals. A means for receiving a signal from the wireless mouse is located on or inside the wireless computer mouse receiver. The wireless computer mouse receiver is connected to a computer.

A person uses the wireless computer mouse receiver of the present invention in a similar method as to using currently available wireless computer mouse receivers. That is, a user first inserts at least one battery into a wireless mouse. Then, the user positions the wireless computer mouse receiver as desired. Software is traditionally provided by the manufacturer of the wireless computer mouse receiver and should be installed on the computer desired to utilize the wireless computer mouse receiver. The wireless computer mouse receiver is then connected to the computer. The user is then able to use the wireless computer mouse in conjunction with the wireless computer mouse receiver of the present invention.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of a wireless computer mouse receiver of the present invention installed on a computer;

FIG. 2 is a top perspective view of the wireless computer mouse receiver of the present invention in use; and

FIG. 3 is a rear plan view of an alternate embodiment of the wireless computer mouse receiver of the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | wireless computer mouse |
| | receiver, generally |
| 2. | exterior body |
| 3. | monitor |
| 4. | computer |
| 5. | wireless mouse |
| 6. | keyboard |
| 7. | desk |
| 8. | signal receiving means |
| 9. | cable |
| 10. | signal |
| 11. | reset button |
| 12. | antenna |
| 13. | base |
| 14. | north tower |
| 15. | south tower |
| 16. | vertical height |

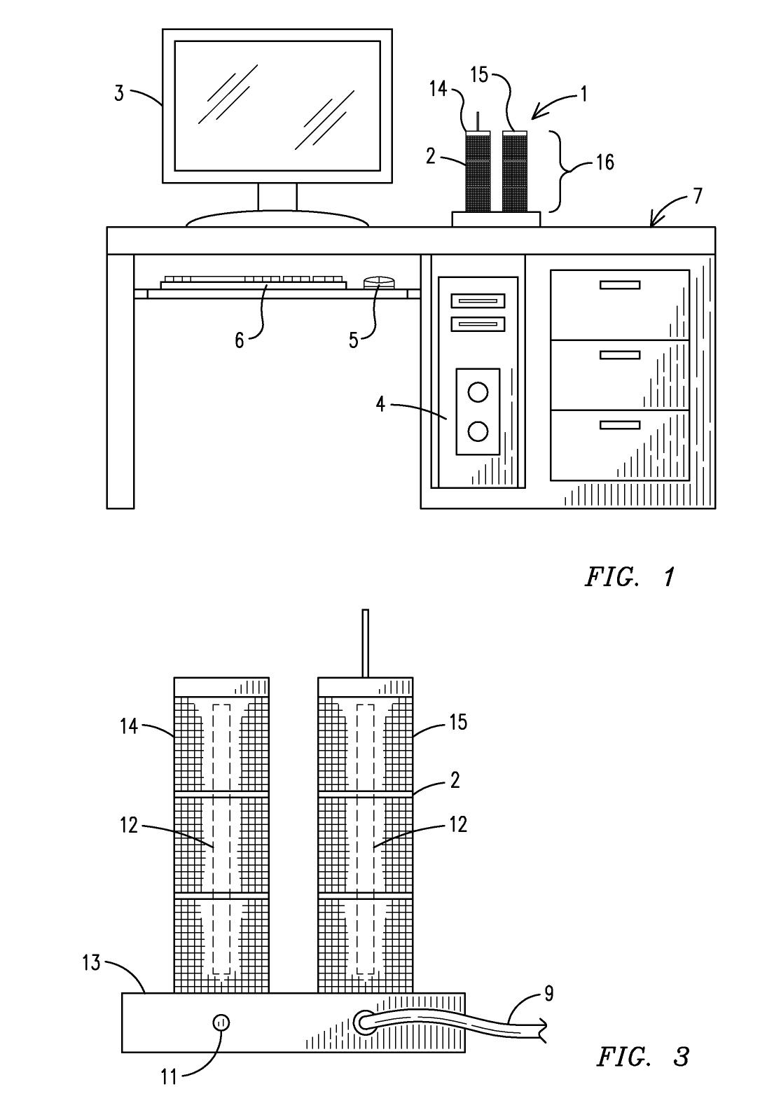

With reference to FIG. 1, a front view of a wireless computer mouse receiver of the present invention installed on a computer. The wireless computer mouse receiver, generally 1 has an exterior body 2 of a predetermined vertical height 16 wherein the body 2 is preferably in the shape of the original World Trade Center having a north tower 14 and a south tower 15, that is, the World Trade Center as constructed prior to the Sep. 11, 2001 terrorist attack. Thus, when the wireless computer mouse receiver 1 is placed on a desk 7 adjacent to a monitor 3, as would most likely be the case when a user is utilizing the wireless computer mouse receiver 1, the wireless computer mouse receiver 1 looks more like a decorative piece of work as opposed to a technological gadget. The wireless computer mouse receiver 1 is connected to a computer 4 and is used in conjunction with a wireless mouse 5. A keyboard 6 accompanies the computer 4 and monitor 3.

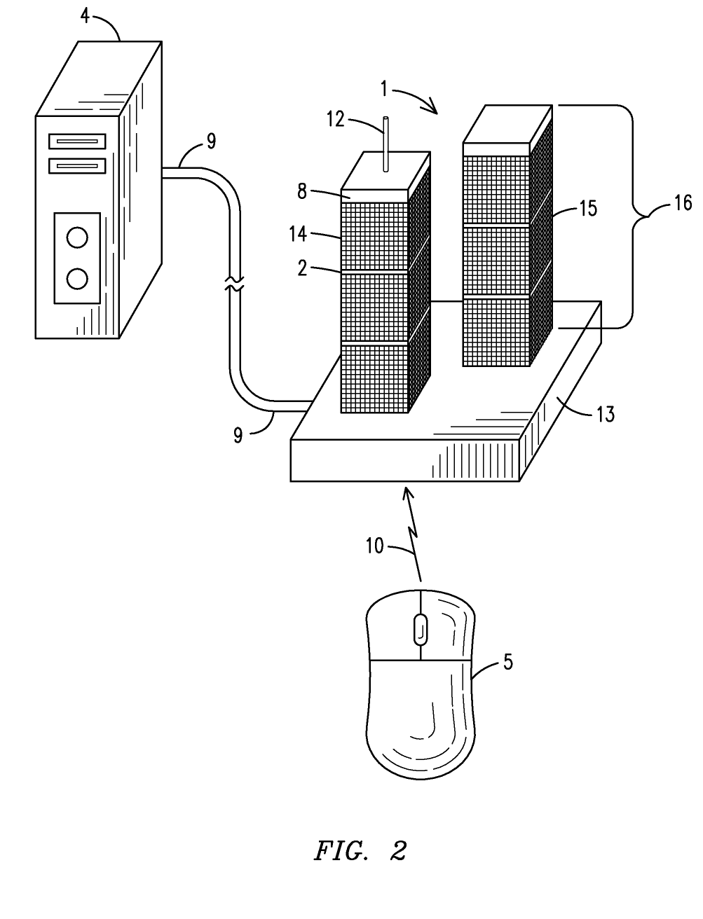

In FIG. 2, a top perspective view of the wireless computer mouse receiver of the present invention in use is illustrated. The wireless computer mouse receiver 1 is used in conjunction with a wireless computer mouse 5 to permit a person to transmit at least one signal 10 to relay data, such as movement of a cursor or selection of an item when a person clicks a button on the wireless mouse 5, to at least one signal receiving means 8, thereby transmitting the data to the computer 4 for displaying on the monitor 3. The wireless computer mouse receiver 1 is connected to the computer 4 via a cable 9 and is therefore able to receive the signals 10 from the wireless mouse 5 to the computer 4. The exterior body 2, which is in the shape of the original World Trade Center, may be attached to a base 13. Although the signal receiving means 8 is shown on the exterior body 2 of the north tower 14, the signal receiving means 8 may also be located in either of the towers 14 or 15, or on the base 13. As the original World Trade Center had an antenna located atop the north tower 14, it is preferable that an antenna 12 is also located on the exterior body 2 of the wireless computer mouse receiver 1 and extends in a vertical direction from the north tower 14. Because the wireless computer mouse receiver 1 has a predetermined vertical height 16 which is greater than those of the substantially flat and low-lying receivers typically used, better reception of the signals 10 is achieved.

Finally, FIG. 3 shows a rear plan view of an alternate embodiment of the wireless computer mouse receiver of the present invention. Rather than having at least one antenna 12 located external to the exterior body 2 of the wireless computer mouse receiver 1, one antenna 12 may be located within one or both towers 14 and 15 of the exterior body 2. A reset button 11 is preferably located on the base 13 of the wireless computer mouse receiver 1, but may also be located at any location on the wireless computer mouse receiver 1.

The use of the present invention will permit better reception between a wireless mouse and the wireless computer mouse receiver.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A wireless computer mouse receiver comprising:
an exterior body having a predetermined vertical height;
a wireless mouse capable of transmitting at least one signal;
a means for receiving said at least one signal from said wireless mouse;
said means for receiving said at least one signal is located on said wireless computer mouse receiver; and
a means for connecting said wireless computer mouse receiver to a computer.

2. The wireless computer mouse receiver of claim 1 wherein:
said exterior body has an appearance of an original World Trade Center having a north tower and a south tower.

3. The wireless computer mouse receiver of claim 1 further comprising:
at least one antenna located on said exterior body wherein said at least one antenna extends in a vertical direction from said exterior body.

4. The wireless computer mouse receiver of claim 2 further comprising:
at least one antenna located on said exterior body wherein said at least one antenna extends in a vertical direction from said exterior body.

5. The wireless computer mouse receiver of claim 1 further comprising:
at least one antenna located within said exterior body.

6. The wireless computer mouse receiver of claim 2 further comprising:
at least one antenna located within said exterior body.

7. The wireless computer mouse receiver of claim 1 wherein:
said at least one signal is a radio frequency signal.

8. The wireless computer mouse receiver of claim 2 wherein:
said at least one signal is a radio frequency signal.

9. The wireless computer mouse receiver of claim 3 wherein:
said at least one signal is a radio frequency signal.

10. The wireless computer mouse receiver of claim 4 wherein:
said at least one signal is a radio frequency signal.

11. The wireless computer mouse receiver of claim 5 wherein:
said at least one signal is a radio frequency signal.

12. The wireless computer mouse receiver of claim 6 wherein:
said at least one signal is a radio frequency signal.

13. The wireless computer mouse receiver of claim 1 wherein:
said at least one signal is a laser signal.

14. The wireless computer mouse receiver of claim 2 wherein:
said at least one signal is a laser signal.

15. The wireless computer mouse receiver of claim 3 wherein:
said at least one signal is a laser signal.

16. The wireless computer mouse receiver of claim 4 wherein:
said at least one signal is a laser signal.

17. The wireless computer mouse receiver of claim 5 wherein:
said at least one signal is a laser signal.

18. The wireless computer mouse receiver of claim 6 wherein:
said at least one signal is a laser signal.

19. The wireless computer mouse receiver of claim 1 wherein:
said means for connecting said wireless computer mouse receiver to a computer is a cable.

20. The wireless computer mouse receiver of claim 1 further comprising:
at least one reset button located on said exterior body.

21. A wireless computer mouse receiver comprising:
an exterior body having a predetermined vertical height;
said exterior body having an appearance of an original World Trade Center having a north tower and a south tower;
a wireless mouse capable of transmitting at least one signal;
a means for receiving said at least one signal from said wireless mouse;
said means for receiving said at least one signal is located on said wireless computer mouse receiver;
a means for connecting said wireless computer mouse receiver to a computer; and
at least one antenna located on said exterior body wherein said at least one antenna extends in a vertical direction from said north tower.

22. The wireless computer mouse receiver of claim 21 wherein:
said at least one signal is a radio frequency signal.

23. The wireless computer mouse receiver of claim 21 wherein:
said at least one signal is a laser signal.

24. The wireless computer mouse receiver of claim 21 wherein:
said means for connecting said wireless computer mouse receiver to a computer is a cable.

25. The wireless computer mouse receiver of claim 21 further comprising:
at least one reset button located on said exterior body.

26. A wireless computer mouse receiver comprising:
an exterior body having a predetermined vertical height;
said exterior body having an appearance of an original World Trade Center having a north tower and a south tower;
a wireless mouse capable of transmitting at least one signal;
a means for receiving said at least one signal from said wireless mouse;
said means for receiving said at least one signal is located on said wireless computer mouse receiver;
a means for connecting said wireless computer mouse receiver to a computer; and
at least one antenna located within said exterior body.

27. The wireless computer mouse receiver of claim 26 wherein:
said at least one signal is a radio frequency signal.

28. The wireless computer mouse receiver of claim 26 wherein:
said at least one signal is a laser signal.

29. The wireless computer mouse receiver of claim 26 wherein:
said means for connecting said wireless computer mouse receiver to a computer is a cable.

30. The wireless computer mouse receiver of claim 26 further comprising:
at least one reset button located on said exterior body.
